(19) United States
(12) Patent Application Publication
(10) Pub. No.: US 2013/0312174 A1
(43) Pub. Date: Nov. 28, 2013

(54) Water Access Lift System

(71) Applicant: Stefan Kanetis, San Diego, CA (US)

(72) Inventor: Stefan Kanetis, San Diego, CA (US)

(21) Appl. No.: 13/872,149

(22) Filed: Apr. 28, 2013

Related U.S. Application Data
(60) Provisional application No. 61/639,906, filed on Apr. 28, 2012.

(51) Int. Cl. A61G 7/10

(52) U.S. Cl. CPC A61G 7/1005
USPC 4/496

(57) ABSTRACT

This application relates to the field of swimming pool access.

### CROSS REFERENCE TO RELATED APPLICATIONS

This application claims the benefit under 35 U.S.C. §119(e) to U.S. Provisional Application Ser. No. 61/639,906 filed Apr. 28, 2012.

### FIELD OF THE INVENTION

This application relates to the field of swimming pool access.

### DESCRIPTION OF THE RELATED ART

Swimming has long been used for recreation, for health benefits, and for a variety of other purposes. The Americans with Disabilities Act (ADA) requires that swimming pools open to the public provide access for people with disabilities. One way to comply with the ADA rules and regulations regarding swimming pools and spa facilities is to install a handicap lift. The purpose of a lift is the safe and efficient ingress and egress of disabled people into a body of water. However, transporting and managing the large portable systems available commercially today is neither safe nor efficient. They are very bulky to maneuver, they take up a lot of storage space, and cost a lot to acquire and maintain. On average, a given lift is used two times per year, and must be replaced every 2-5 years. Additionally, the viability and implementation of the systems in use today, given pending changes in ADA regulations, is an open question. Other factors rendering the old type of lift obsolete are: corrosion issues, excessive maintenance costs, the risk of injury due to misuse, theft and vandalism.

### SUMMARY OF THE INVENTION

Some embodiments relate to a self-contained lift system for lifting a disabled person into and out of a swimming pool. In some embodiments, for example, the lift can include a lift post, a swivel arm, and a platform. The platform can be connected to a first end of the swivel arm, and the lift post can be connected to a second end of the swivel arm. The lift post can be vertically displaced from a first vertical position to a second vertical position, and can be rotated from a first angular position to a second angular position.

In some aspects of the lift system, the lift post can be a hydraulic cylinder. In some embodiments, the lift post comprises a stationary outer tube, and a moveable inner tube which can be displaced from a first vertical position to a second vertical position.

In some embodiments, the swivel arm is attached to the lift post at a 90 degree angle. The swivel arm can also be attached to the lift post with a pivoting connector. The pivoting connector allows the swivel arm to be folded until it is substantially parallel with the lift post.

In some embodiments of the lift system, the platform comprises a bottom section and a back section. In some embodiments, for example, the platform comprises a seat. The seat can be securely attached to the swivel arm, and in some embodiments the seat can be detachable from the swivel arm. To facilitate storage, the seat can also be a folding seat.

In some aspects of the lift system, the lift post, swivel arm, and platform fold together and fit into a storage box. In various embodiments, the storage box can be maintained below ground level, above ground level, or partially below ground level. To reduce corrosion and keep the lift system secure, the storage box can be water tight and air tight.

Some embodiments relate to a method of using a lift system to move a person from a first position next to a swimming pool to a second position in the water of the swimming pool. In order to move the person into the pool, the person is first secured to a platform, then moved with the platform from a first vertical position to a second vertical position, rotated with the platform from a position above the deck next to the swimming to a position over the water of the swimming pool, and then lowered from the position above the water of the swimming pool to a position where the person and the platform are submerged in the water, and then unsecuring the person from the platform.

In some embodiments, for example, the platform can be a seat, which may have arms, and/or a seatbelt.

Additionally, the steps can also be performed in reverse, in order to move a person from the water of a swimming pool to a second position on the pool deck next to the swimming pool.

The foregoing is a summary and thus contains, by necessity, simplifications, generalizations, and omissions of detail; consequently, those skilled in the art will appreciate that the summary is illustrative only and is not intended to be in any way limiting. Other aspects, features, and advantages of the devices and/or processes and/or other subject matter described herein will become apparent in the teaching set forth herein. The summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings.

FIG. 1 is a perspective view of one embodiment of a hydraulic aquatic lift.

FIG. 2 is a side view of one embodiment of a stored hydraulic aquatic lift.

FIG. 3 is a side view of one embodiment of an extended hydraulic aquatic lift.

FIG. 4 is a rear view of one embodiment of an extended hydraulic aquatic lift.

FIG. 5 is a perspective view of one embodiment of an extended hydraulic aquatic lift.

FIG. 6 is an isolated perspective view of one embodiment of an extended hydraulic aquatic lift.

FIG. 7 is a series of views of one embodiment of a hydraulic aquatic lift.

FIG. 8 is a series of views of an alternate embodiment of a hydraulic aquatic lift.

FIG. 9 is a perspective view of one embodiment of a storage box for a hydraulic aquatic lift.

FIG. 10 is a top view of several different embodiments of a hydraulic aquatic lift.

FIG. 11 is a side view of one embodiment of a hydraulic aquatic lift.

FIG. 12 is a side view of one embodiment of a post and arm assembly.

FIG. 13 is a perspective view of one embodiment of an in-ground hydraulic aquatic lift.

FIG. 14 is a side view of one embodiment of a post and arm assembly.

FIG. 15 is a top view of one embodiment of an in-ground hydraulic aquatic lift.

FIG. 16 is a perspective view of one embodiment of an in-ground hydraulic aquatic lift.

FIG. 17 is a perspective view of one embodiment of a holding box.

FIG. 18 is a perspective view of one embodiment of a chair.

FIG. 19 is a side view of one embodiment of a chair.

FIG. 20 is a perspective view of one embodiment of a chair attachment assembly.

FIG. 21 is a perspective view of an alternate embodiment of a chair attachment assembly.

FIG. 22 is a side view of one embodiment of a lift post.

FIG. 23 is a side view of one embodiment of a lift post.

FIG. 24 is a perspective view of one embodiment of a hydraulic aquatic lift.

FIG. 25 is a perspective view of one embodiment of a hydraulic aquatic lift.

FIG. 26 is a side view of one embodiment of a hydraulic aquatic lift.

### DETAILED DESCRIPTION OF THE PREFERRED EMBODIMENT

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

In some embodiments, the hydraulic aquatic lift comprises a self-contained, folding, retractable, hydraulic lift chair designed to allow handicapped or disabled persons easy and safe access to a swimming pool or spa. The lift system can be employed by people with motor disabilities and/or people in wheelchairs to get in and out of swimming pools, thus mitigating the usual difficulties and inconveniences normally expected when going swimming, whether for therapeutic reasons or for recreation.

In some embodiments, the secure, retractable device rises up from its in-ground enclosure and folds out in quick, safe, and efficient manner. The disabled person can then easily access the chair, which can then be lowered into the water in a smooth, controlled fashion. The disabled person can then easily glide away from the chair for a swimming or therapy session. If desired, the chair can then be raised to get it out of the water, then lowered again to receive the person after the session. When the person is finished swimming, he or she simply returns to the submerged chair, which can then be lifted and rotated to safely deposit the person poolside so they can exit the chair.

One of the primary objectives of the hydraulic aquatic lift system is safety. In some embodiments, the system can be configured to be used by a disabled person, or by a single person, without assistance. In some embodiments, the comfortable, submersible chair is attached to and stored with the lift system. In other embodiments, the chair is detachable and may have wheels so it can also be used as transport in addition to serving the lifting function. With wheels, the chair can be used to go from a changing room to the pool deck, a hotel room to the pool deck, or to and from other similar access points. The chair can then be easily attached to the lift via a pin and receiver, or other suitable attachment system, and used to safely enter and exit the pool.

Additional safety features of the lift system include prevention of any lateral motion of the system while it is in use, so the chair cannot strike the side of the pool.

In some embodiments, the lift system can be housed in a secure container. The container can be permanently installed either in the ground or above ground, keeping the system secure in a self-contained enclosure, which can be water-tight and air tight to prevent corrosion. In some embodiments, the lift system folds and retracts completely into the container, which can be closed with a lid that has an o-ring for sealing. In other embodiments, the chair and/or the swivel arm can be detached and stored remotely from the lift cylinder.

In some embodiments, the lift system incorporates design features intended to minimize the system's impact on the surrounding area. All embodiments allow for simple and convenient installation. When installed using the underground storage container, the lid is flush with the pool deck, and nothing can be viewed above-ground except the top face of the lid. All other components of the system are completely hidden during non-use. Additionally, some embodiments feature ultra quiet operation, which is beneficial, for example, if installed in a hotel setting. The operation of the system will not disturb other guests who are poolside or nearby in their rooms.

Various embodiments have options for portability, storage, and form factor. In some embodiments parts of the system can be stored separately from one another, allowing many choices for installation, in order to minimize any impact on the design of the pool area or surrounding landscapes.

Some embodiments can use standard 110-volt power or lower-level voltage, thus further allowing for convenient installation and utilization of conventional power resources.

Embodiments of the lift system are designed to comply completely with ADA legal standards. The lift system exceeds the thresholds set for weight bearing, tensile strength, and performance.

Different embodiments also allow the lift system to be utilized by not only by humans, but for zoological applications as well.

A Hydraulic Acquatic Lift

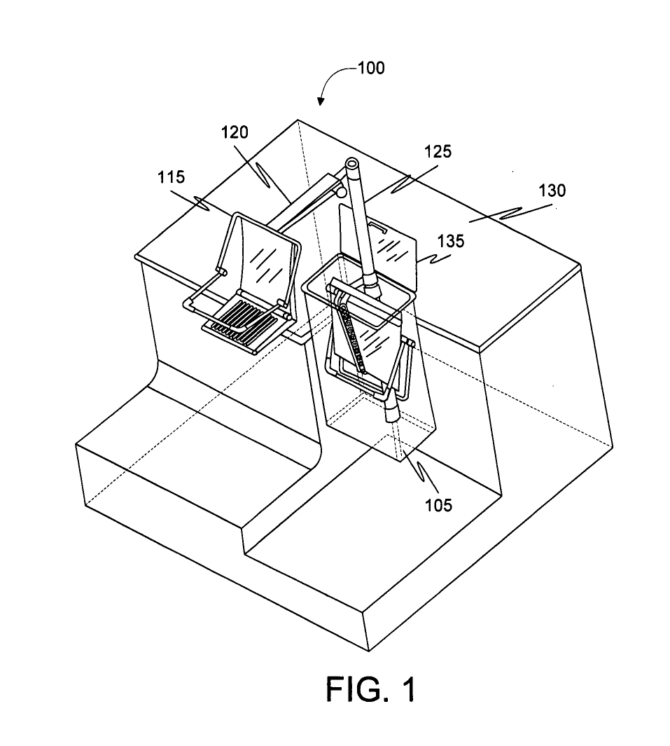

FIG. 1 is a perspective view of one embodiment of a hydraulic aquatic lift 100. In some embodiments, the hydraulic aquatic lift system 100 comprises a platform or chair 115, a beam or swivel arm 120, a lift post 125, a storage container 105, and a storage container lid 135. The embodiment shown is installed underground and flush with the pool deck 130.

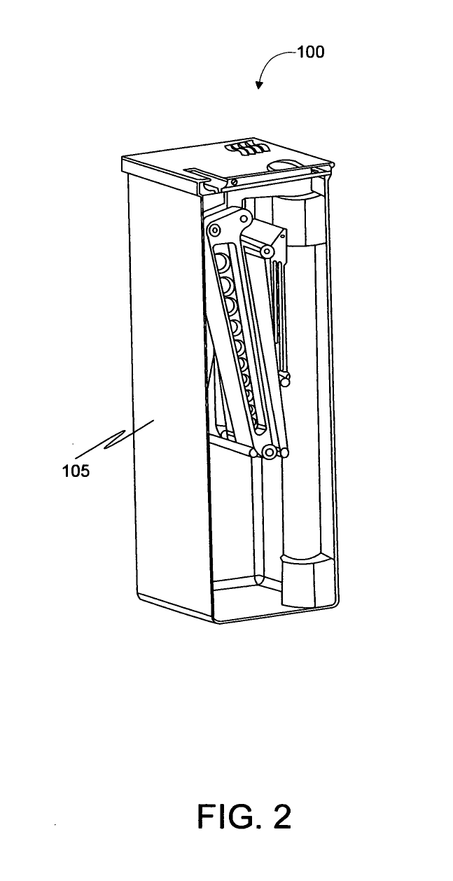

FIG. 2 is a side view of one embodiment of a stored hydraulic aquatic lift 100. In some embodiments, the hydraulic aquatic lift system 100 can be completely folded in on itself to stow in a container 105 when not in use.

In some embodiments, the lift system 100 can be stored, housed, and based in an in-ground, water-proof, secure storage container 105. The container 105 can be installed completely or partially underground, and when the lid is closed can produce a water-tight enclosure.

The container 105 is adequate in size so that when all the components of the lift system 100 are folded and lowered into the container 105 the lift system 100 becomes completely flush with the ground. Lowering the visual footprint of the lift system 100 makes it convenient and appealing to install in upscale and high-end hotels, resorts, spas, and recreational areas, as well as standard hotel and motel swimming pools. The container 105 can comprise a variety of materials, including stainless steel, fiberglass, plastic, composites, concrete, or any other suitable material.

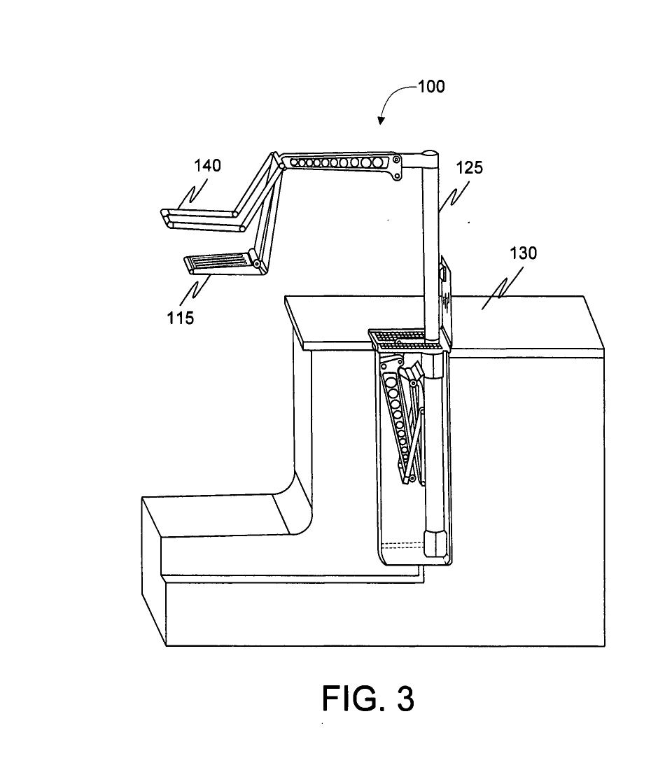

FIG. 3 is a side view of one embodiment of an extended hydraulic aquatic lift 100. The lift system 100 is depicted in two positions: a lifted, extended position, and also in a stowed, folded configuration. In the embodiment shown, the post 125, arm 120, and chair 115 are above the pool deck 130 when in the lifted position. Also shown is a chair safety bar 140. In other embodiments, the chair 115 could have other safety mechanisms, including a seat belt, arms, or other suitable safety mechanism.

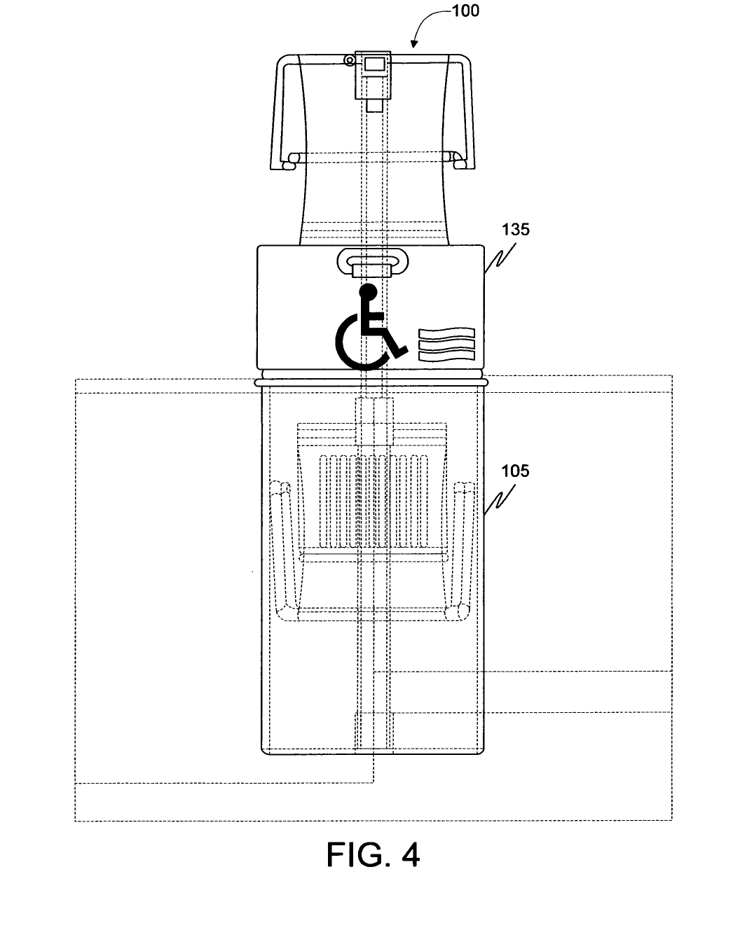

FIG. 4 is a rear view of one embodiment of an extended hydraulic aquatic lift 100. The lift system 100 is depicted in two positions: a lifted position, and also in a stowed, folded configuration. The lid 135 is depicted with symbols. The container 105 is shown in the below-ground configuration.

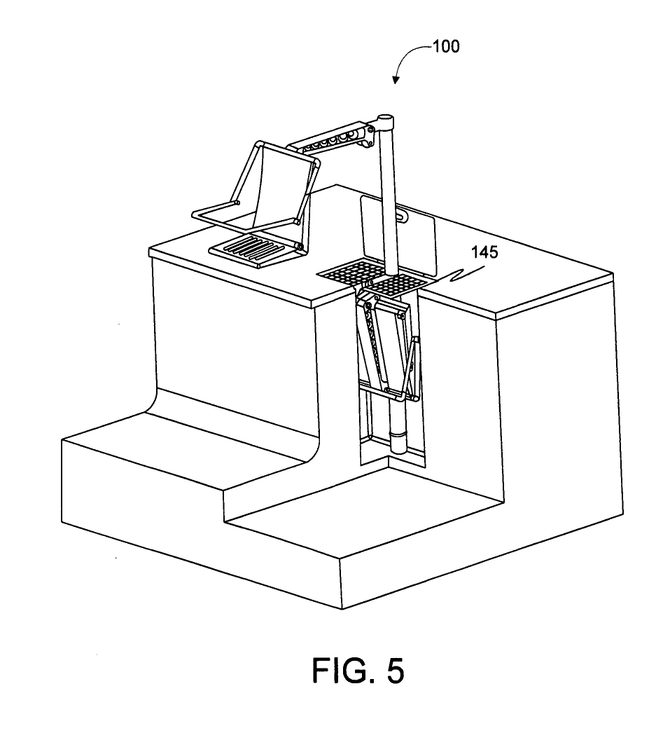

FIG. 5 is a perspective view of one embodiment of an extended hydraulic aquatic lift 100. The lift system 100 is depicted in two positions: a lifted, extended position, and also in a stowed, folded configuration. Also shown is safety grate 145, which keeps debris and body parts out of the container while the system 100 is in use.

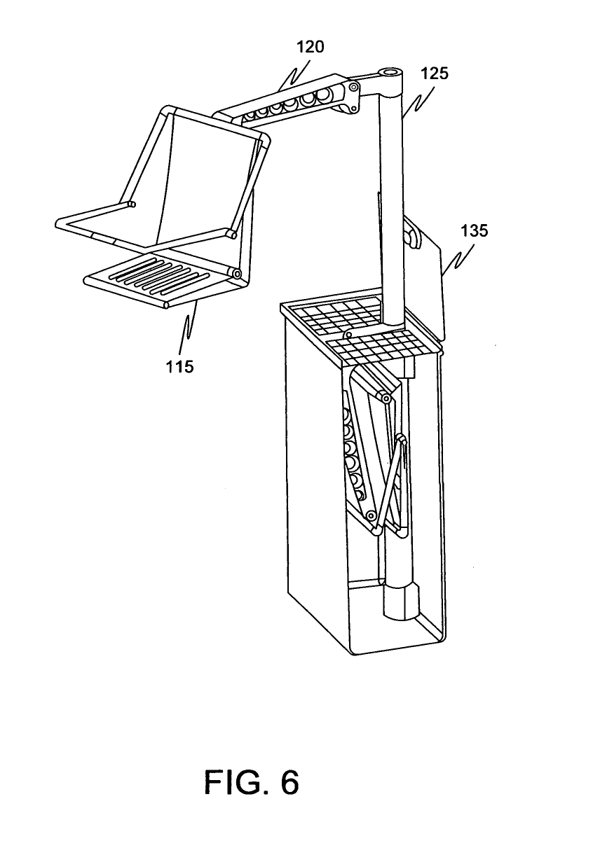

FIG. 6 is an isolated perspective view of one embodiment of an extended hydraulic aquatic lift 100. The lift system 100 is depicted in two positions: a lifted, extended position, and also in a stowed, folded configuration. In some embodiments, the container 105 can also be used as a shiiping container for the lift system 100. When the system 100 is in use, the lid 135 is open, and the post 125, arm/beam 120, and chair/seat 115 are all in extended positions.

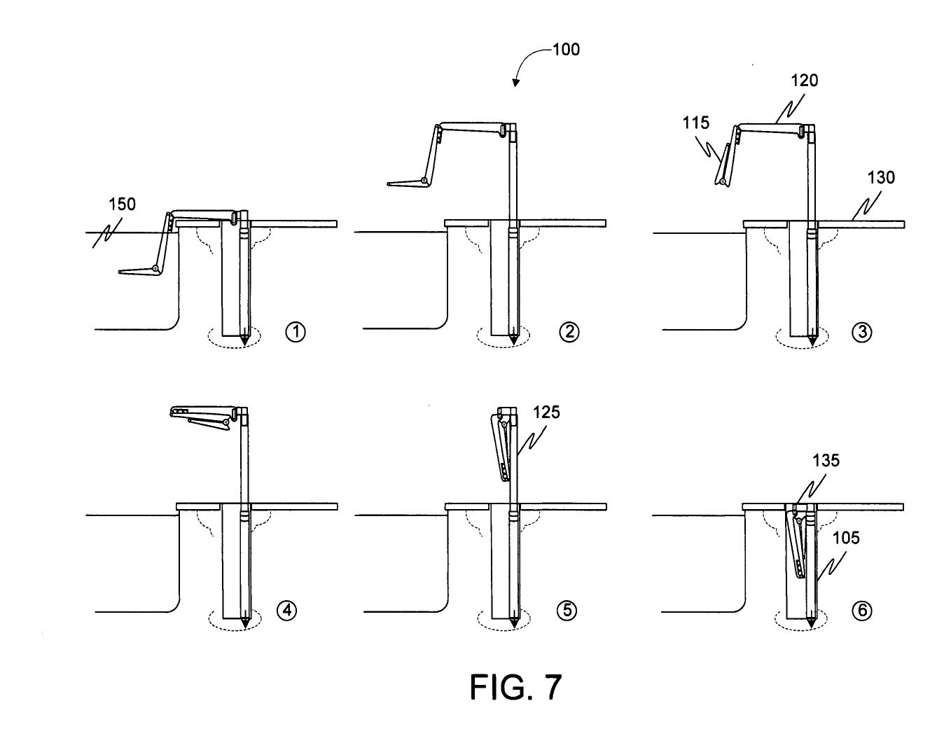

FIG. 7 is a series of views of one embodiment of a hydraulic aquatic lift 100. A six-part sequence is shown:

Step 1 shows the lift system 100 extended and lowered into the swimming pool water 150.

Step 2 shows the lift system 100 extended and raised above the swimming pool water 150.

Step 3 shows the lift system 100 extended and raised above the swimming pool water 150, with the chair 115 in a first folded configuration.

Step 4 shows the lift system 100 extended and raised above the swimming pool water 150, with the chair 115 in a second folded configuration, parallel to/against the swivel arm 120.

Step 5 shows the lift system 100 extended and raised above the swimming pool water 150, with the chair 115 folded parallel to/against the lift post 125.

Step 6 shows the lift system 100 retracted completely into the storage container 105, with the lid 135 closed.

In some embodiments, each motion of the lift system 100 can be actuated and/or controlled by a servo motor, electric motor, or series of motors. This embodiment could also include limit switches, where upon completion of the motion of one or more of the motors, the next motor would be triggered.

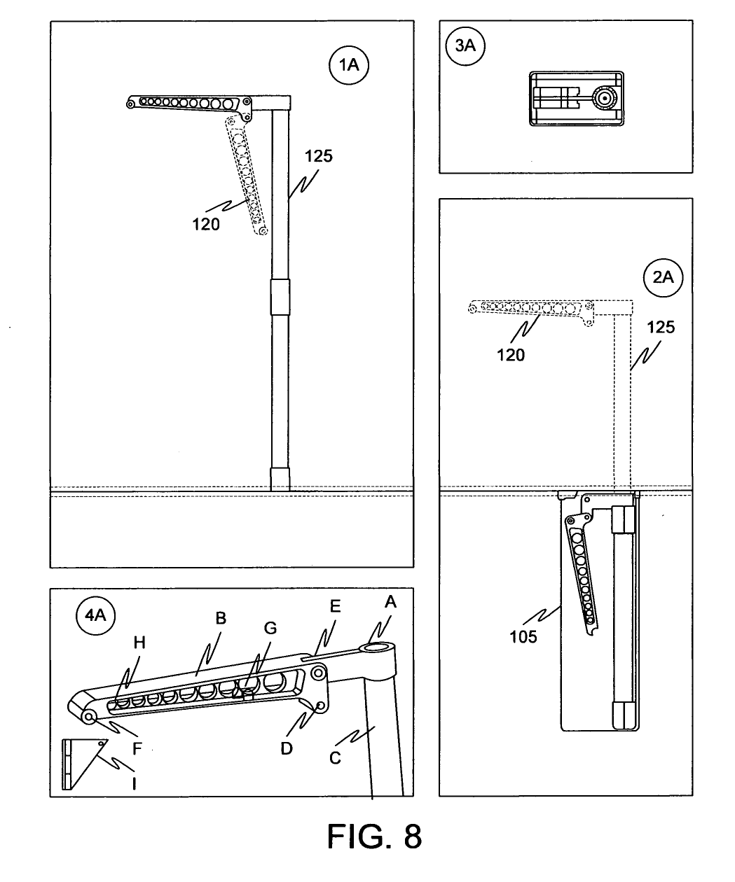

FIG. 8 is a series of views of an alternate embodiment of a hydraulic aquatic lift 100.

View 1A is a side view of one embodiment of the lift system 100, where the post 125 is bolted to the ground or pool deck in an above-ground configuration. The swivel arm 120 is shown with a pivoting connection to the post 125, and is shown in both extended and folded positions.

View 2A is a side view of one embodiment of the lift system 100, where the lift system 100 folds for storage underground in a container 105.

View 3A is a top view of the in-ground system.

View 4A is an isometric view of one embodiment of the beam/arm 120. The arm 120 is used to rotate to any position that is best suited for the disabled person to get into the chair and be rotated into position to be lowered into the water, and subsequently rotated back to the original position. The arm 120 is designed to be in compliance with ADA regulations so that the disabled person can operate the system 100 alone if required.

The arm 120 as illustrated is designed to fold, however, an alternative embodiment has a similar configuration and function but does not fold and retract.

The arm 120 must be of sufficient length to rotate the attached chair 115 directly over the water.

In some embodiments, the arm 120 is comprised of two parts. The non-folding version could be one piece and not have the hinge point.

The arm 120 is attached to the lift post 125 in use, but when not in use it is detachable. It could be removed and stored in a decorative holding box that could be any legal distance from the pool.

Referring now to the isometric view 4A:

Part “A” is connected to the post 125 and can be the rotational point of the arm 120, or alternatively can be connected in a stationary manner to the post 125 where the post 125 can be rotated instead.

Part “B” is the required length for rotation of the chair 115 to the pool's edge.

Part “C” is the post 125.

Part “D” is the stainless steel rod which is the pivoting point of the folding arm 120, designed to remain with the arm 120. It is a rod or pin that is removed but connected to the arm 120 with a wire or chain so as to prevent loss or damage.

Part “E” is parallel to the ground when the arm 120 is in use and aligns with holes in parts “A” and “B”. A pin is inserted in “E” to hold the arm 120 in place, which allows the arm 120 to fold against the post 125.

Part “F” is the rotational rod point and is connected to the back of the chair 115, which allows the chair 115 to fold and clip to the arm 120.

Part “G” is the clip connected to the arm 120.

Part “H” is a connecting point on the arm 120 for a folding gusset in the back of the chair 115.

Part “I” is hinged, and when opened and locked place to “H” of the arm 120, prevents the chair 115 from swinging.

Part “I” is the hinged gusset connected to the chair 115.

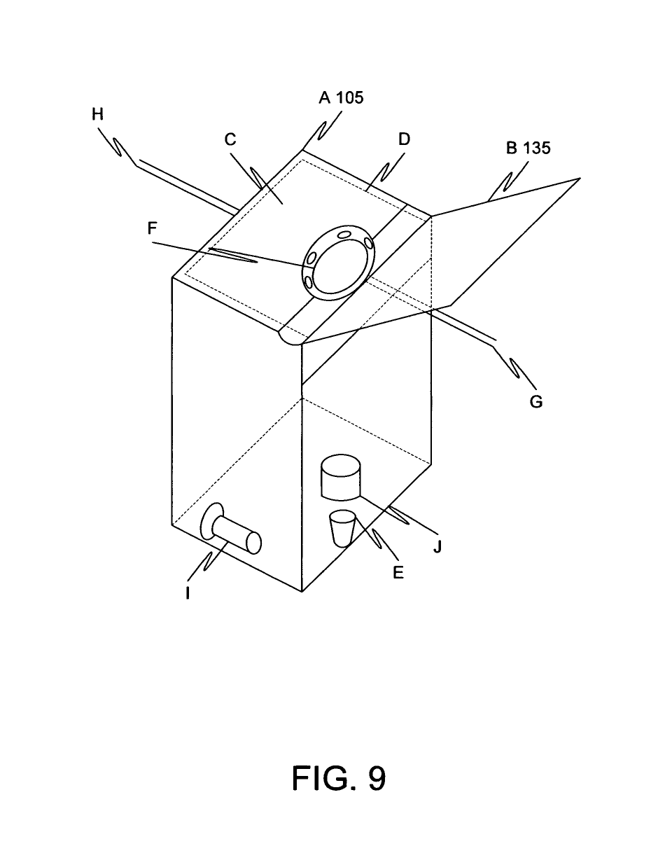

FIG. 9 is a perspective view of one embodiment of a container 105 for a hydraulic aquatic lift 100. In the illustrated embodiment, the container 105 is also labeled as Part “A”.

Part “B” is the sealed lid 135. It can be an air-tight and water-tight seal with an O-ring. It can sit flush with the top level of the pool deck 130. When closed, the lid 135 can level with the surrounding surface of the swimming pool deck 130, and in this configuration the top face of the lid 135 is the only visible portion of the container 105. In a preferred embodiment, the lid 135 can be made of stainless steel, and can have an acid-etched standard Handicapped insignia on it as well as any customization desired.

Part “C” is the interior second lid. When the first lid 135 is opened, it provides access to the second lid. The objective of the second lid is to provide a locked, secure access point to the lift system 100. Another objective of the second lid is to prevent unauthorized usage, vandalism, or theft, and to prevent accidental falling into the container.

Part “D” is an O-ring or any other suitable seal.

Part “E” is the post 125 or cylinder receiving cavity. The purpose of this part is to secure the bottom end of the cylinder or any other type of similar mechanism. The cavity can be tapered, and would receive any counter-part protruding from the lifting cylinder 125.

Part “F” is a structural receiving sleeve. This has coordinated, threaded bolt holes that match-up with the cylinder 125.

Part “G” is a water or liquid supply line to the container 105.

Part “H” allows water to be fed to and from the pool when used with a pump (Part “I”) or used as a water dump. When led from a hose, a pool/sump pump or any other similar pump can be installed into the container 105. A pump would require a low-voltage electric supply.

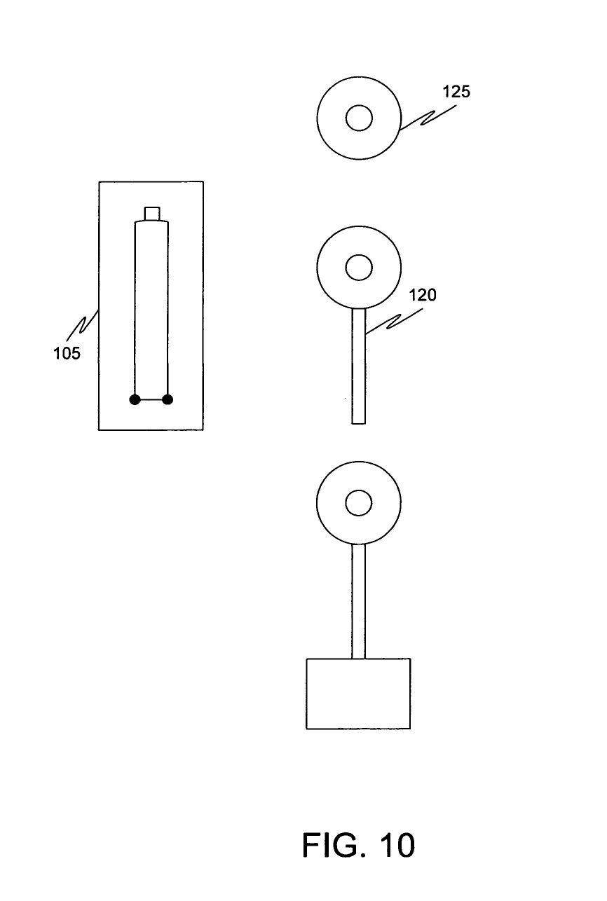

FIG. 10 is a top view of several different embodiments of a hydraulic aquatic lift 100.

Alternative method 1 shows an embodiment where only the hydraulic post 125 is installed in the ground. The beam/arm 120 and chair 115 are stored elsewhere. This embodiment would be ideal for retrofit systems, because the extent of digging required for installation is minimal. Only an approximately 6-12″ augered hole would be needed for the post 125, and the system 100 would still have all of the benefits of an underground system, such as out-of-sight storage.

Alternative method 2 shows an embodiment where the hydraulic post 125 and beam/arm 120 are installed in the ground, and chair 115 is stored elsewhere.

Alternative method 3 shows an embodiment where the hydraulic post 125, beam/arm 120 and chair 115 are installed in the ground and flush with the pool deck, but not folded into a container as shown in other embodiments.

Alternative method 4 shows an embodiment where the post 125 is employed with a swivel from a horizontal configuration. In some embodiments, the system 100 could operate from a shallow horizontal container/box 105.

In addition to these four proposed embodiments, other embodiments are also contemplated in this specification.

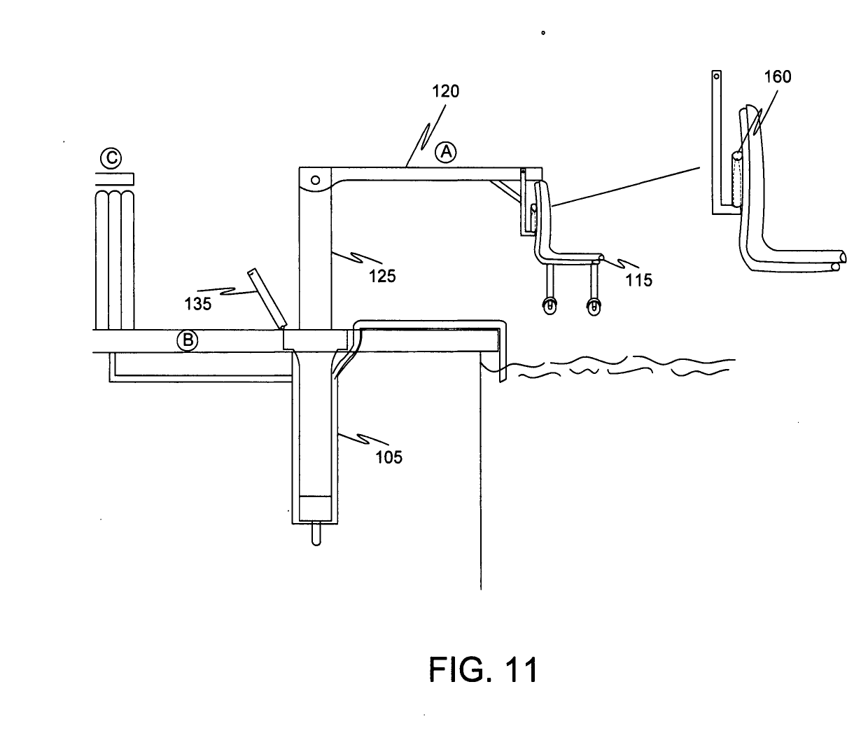

FIG. 11 is a side view of one embodiment of a hydraulic aquatic lift 100. Shown are the basic components of the lift system, including the hydraulic/pneumatic post/cylinder 125, the swivel arm/beam 120, and the chair 115. The chair 115 is shown with wheels, and one possible chair connection system 160. The beam 120 is shown connected to the post/cylinder 125 with a 1½″ stainless steel pin that slides into the cylinder 125. The cylinder 125 is pictured with a 48″ stroke, although other heights are contemplated. The cylinder 125 could also be a two-stage cylinder, to minimize the necessary excavation depth.

Also shown is the container lid 135, and an embodiment of an in-ground container 105, which shows a stability pin at its base. The chair 115 and beam/arm 120 could be stored remotely from the cylinder/post 125, for example in a decorative, lockable box.

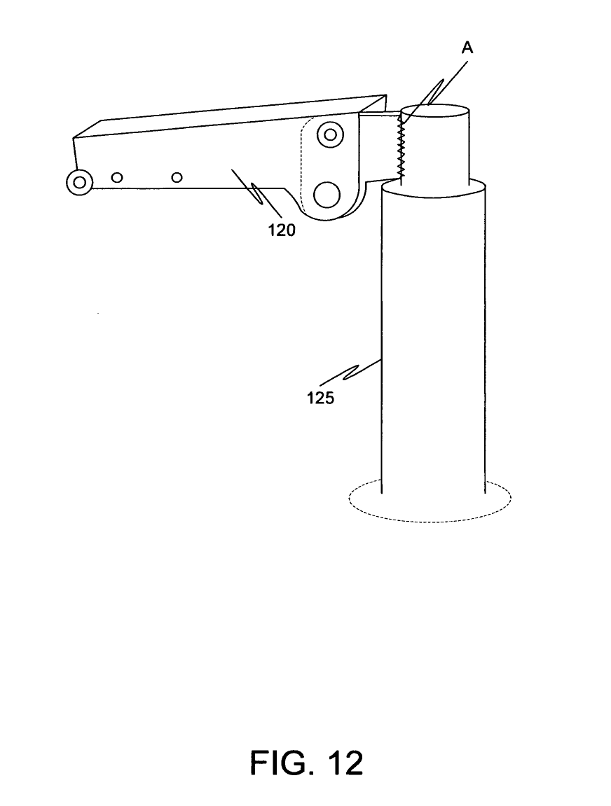

FIG. 12 is a side view of one embodiment of a post 125 and arm 120 assembly. In some embodiments, the arm 120 can be welded to the post/cylinder 125, or the post 125 could have a bracket which attaches to the arm 120 with bolts, pins, or a weld. The attachment point could be a pivoting mechanism. The arm 120 can also have features to support or stabilize the chair 115, including gussets, pins, clips, or other suitable mechanisms.

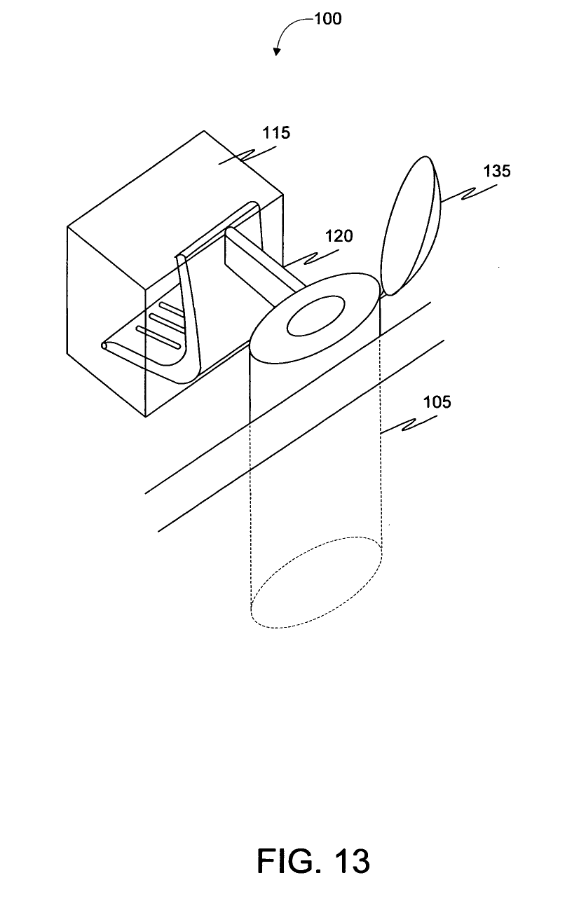

FIG. 13 is a perspective view of one embodiment of an in-ground hydraulic aquatic lift 100. This embodiment shows a circular container 105 for the post 125, and a lid 135. The beam 120 could also be installed into an underground channel or groove, and optionally the chair 115 could be stored in an underground container as well.

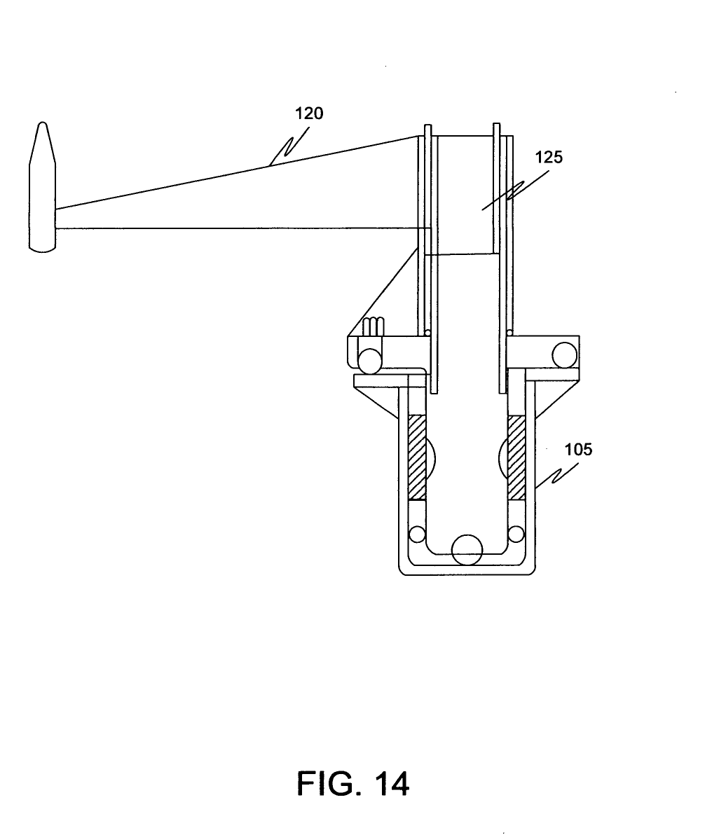

FIG. 14 is a side view of one embodiment of a post 125 and arm 120 assembly. Shown is an articulating, extending post 125, with an attached arm 120. The arm 120 includes one embodiment of an attachment point for a chair. The container 105 is shown with PVC lining, and a flange bolted to the pool deck.

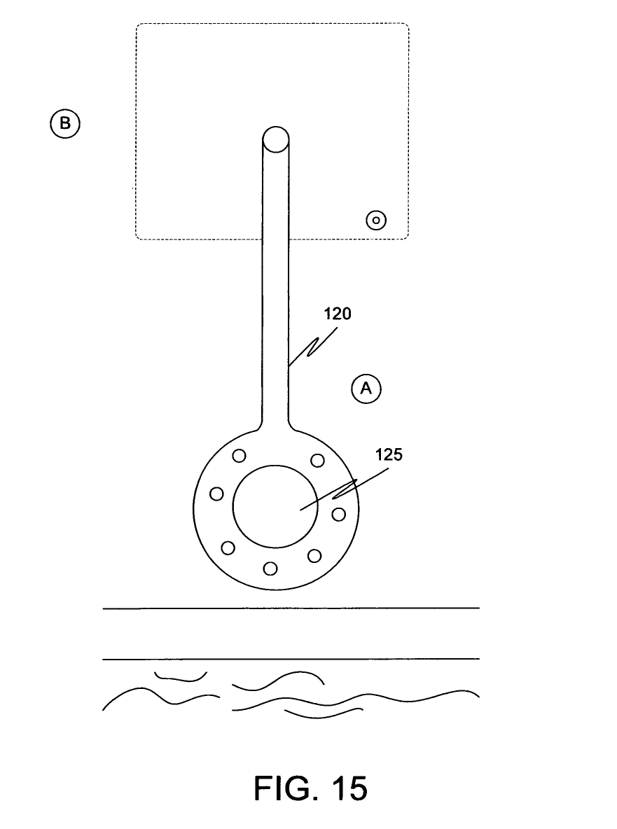

FIG. 15 is a top view of one embodiment of an in-ground hydraulic aquatic lift 100. In this embodiment, the post 125 is in a cylindrical container underground, and when fully lowered it is level with the pool deck surface. The attached beam/arm 120 can have a receiving cavity/channel so that it is also level with the pool deck surface when lowered. The chair 115 could be stored in an underground container as well, which could include a lid. The entire lift system 100 could be installed next to a swimming pool, so that the chair 115 could be rotated out over the water and lowered when in use.

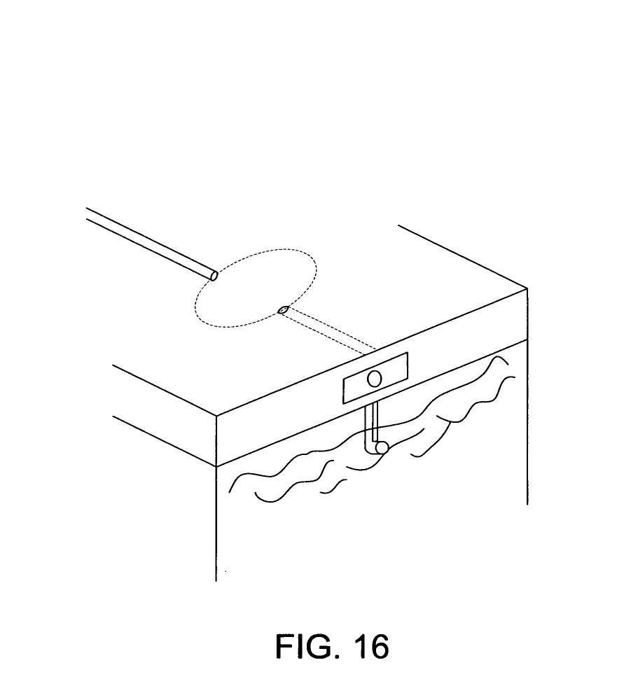

FIG. 16 is a perspective view of one embodiment of an in-ground hydraulic aquatic lift 100. In this embodiment, one version of the hydraulic pump plumbing is shown. Water can be piped into and out of the post/cylinder by a pump, and either expelled to the pool, or reversed to the pump. As an alternative to water, antifreeze or any other suitable liquid could be used. One benefit of the shallow piping for the pump operations is that only a small slot needs to be cut and grouted.

Also shown in this embodiment is a control switch mounted on the side of the pool coping, allowing a user to control the lift system 100.

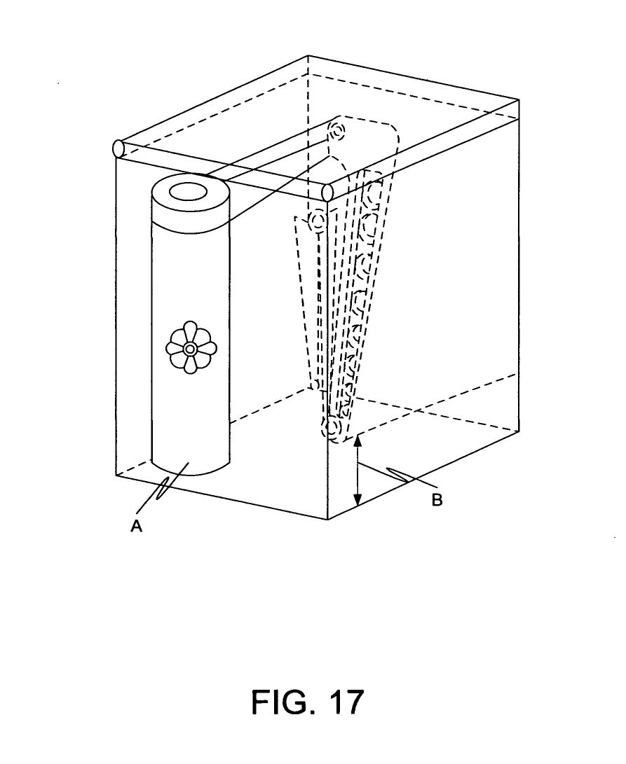

FIG. 17 is a perspective view of one embodiment of a holding box. In some embodiments, parts of the system 100 are stored away from the edge of the pool. The holding box can store the arm/beam 120, and/or the chair 115, or any other component of the system 100. The chair 115 can be a fully erect chair, or a folding chair, and/or it may or may not have wheels. The holding box may be installed partially or fully in the ground.

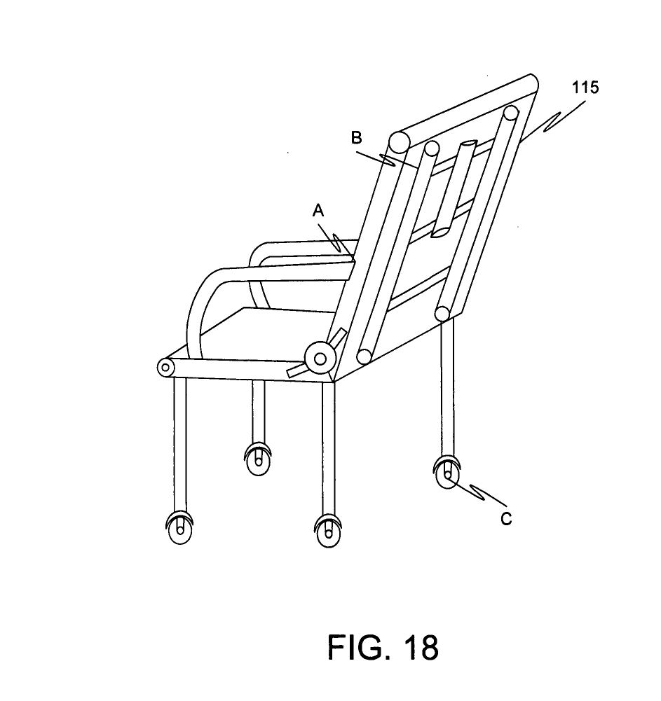

FIG. 18 is a perspective view of one embodiment of a chair 115. In some embodiments, the lift system 100 can include a detachable chair 115. The chair may include a suitable attachment/mating assembly to allow it to be installed on the beam/arm 120 for lifting purposes. The chair 115 may also include wheels of any suitable size to make it mobile. One of the advantages of a mobile chair is that a person with disabilities may dress and prepare for swimming in a private area, and then roll the chair out to the pool/lift area. The person will not have to transfer to another platform for lifting into and out of the pool, because the rolling chair 115 is configured to engage with the lift system. The chair can be made of plastic, metal, fabric, or any other suitable material for submerging in water. By using the wheeled chair associated with the lift system, the user does not have to get his or her own chair wet, or worry about shifting from one chair to another. The rolling chair 115 can then be used after swimming to return to a private changing area.

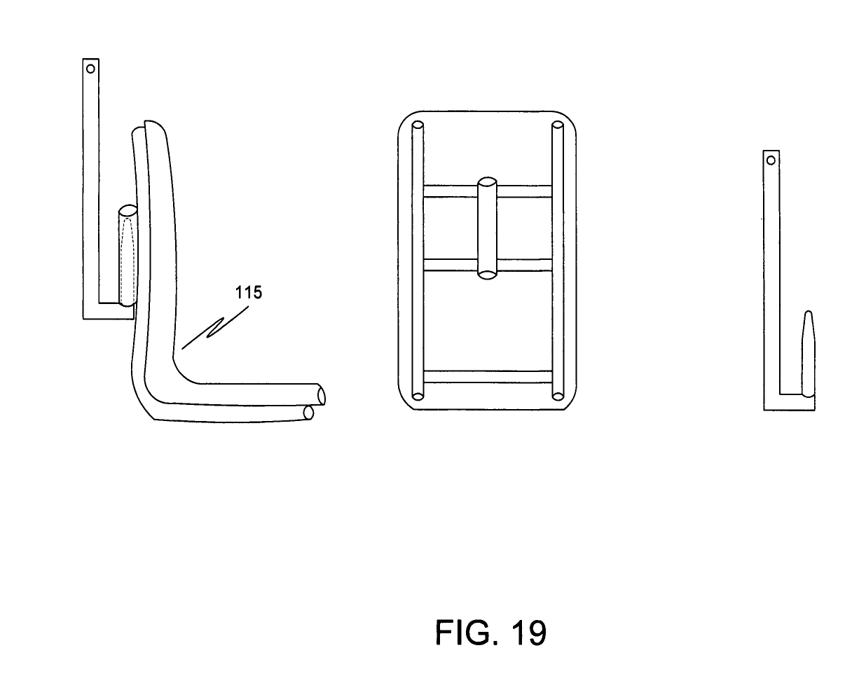

FIG. 19 is a side view of one embodiment of a chair 115. Shown is one embodiment of a chair 115, made of solid plastic and mounted to a metal frame. Also shown is one embodiment of a system for connecting the chair 115 to the beam/arm 120. The connection system 160 includes a vertical post hanger to accept the chair, with a pin which can be made of stainless steel mounted at the bottom. The back of the chair frame has the mating connector, illustrated here as a tube welded to the frame.

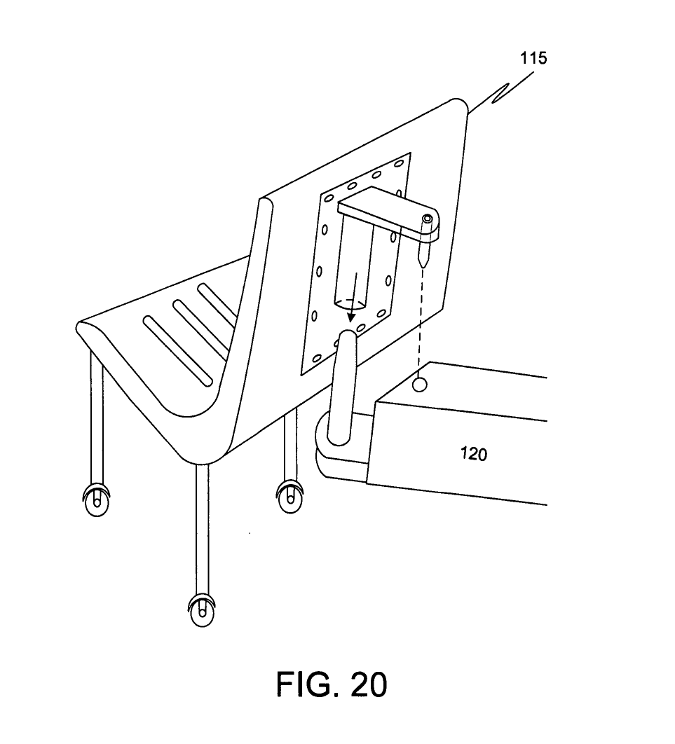

FIG. 20 is a perspective view of one embodiment of a chair 115 attachment assembly. Shown is one embodiment of the chair connection assembly 160. Shown is a pin mounted on the arm 120, and a mating tube on the back of the chair 115. This configuration could be reversed, and many other alternate connections are possible. The beam 120 to chair 115 connection cold also be positioned elsewhere on the chair. Also shown in this embodiment is an anti-rotational pin that is part of the chair connection system 160, which is designed for safety of the chair and user.

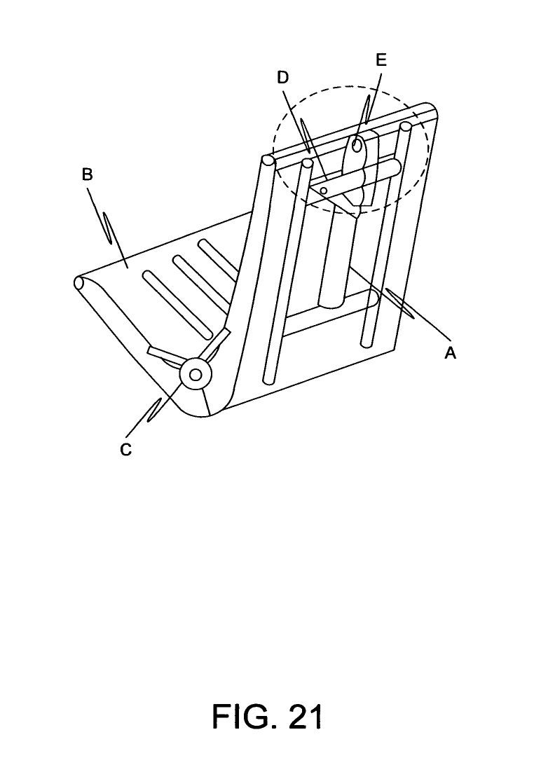

FIG. 21 is a perspective view of an alternate embodiment of a chair 115 attachment assembly. Shown is an embodiment of a folding chair 115. The chair 115 is designed to ergonomically and safely hold the user while being raised or lowered into the swimming pool or body of water. This embodiment is designed to fold and rotate. When rotated completely it can clip into the arm 120. The arm 120 together with the chair 115 pivots to the post 125 and folds inward, making a tight, compact package ready to be lowered into the water-tight in-ground container 105. The chair 115 has all the safety features required by law.

The chair 115 can have different embodiments; it can have arms or not, it can have a foot-rest or not, it can be made of stainless steel, plastic, acrylic, fabric, or any other material that will hold the required weight and not deteriorate.

The chair 115 has an embodiment where it can be detached and stored separately in a water-tight, decorative box.

The chair 115 can comprise a safety-belt or strap.

In some embodiments, the chair 115 is without wheels, and the chair is stored with the lift system 100 in the container 105.

In some embodiments, the chair 115 has wheels so that it may be easily utilized within the local area to facilitate easy transportation of users within the area. This chair 115 can be stored away from the container in a decorative container or inside the local facility, such as a dressing room or hotel room. A secondary chair 115 may also be used for this purpose.

The chair 115 is not limited to only lifting humans; it has marine animal or zoological capabilities as well.

Referring now to the drawing:

Part “A” is the structural portion of the chair 115 that when folded, can be secured by the receiving clip in the arm 120.

Part “B” is the folding seat part of the chair 115.

Part “C” is a heavy-duty structural hinge capable of handling and exceeding ADA weight requirements.

Part “D” is an attached, folding gusset.

Part “E” is a rotational pivot point connecting the chair 115 to the receiving pivot point on the arm 120.

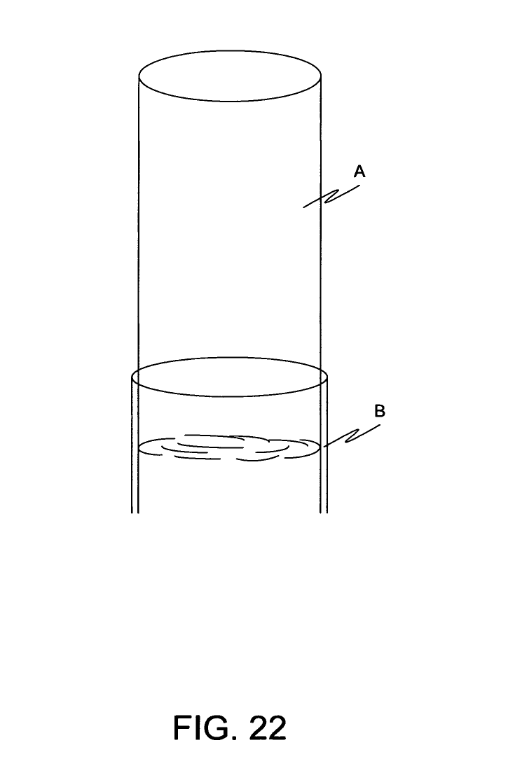

FIG. 22 is a side view of one embodiment of a lift post 125. Shown is the central post, shaft, tube, or cylinder, inside the cooperating holding tube.

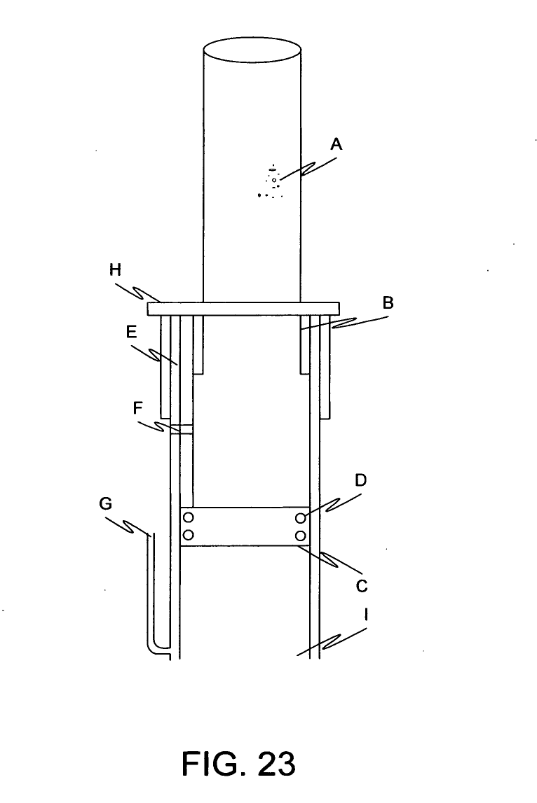

FIG. 23 is a side view of one embodiment of a lift post 125. The linear, structural post or shaft 125 is one of the key components of the lift system 100. It is the “lifting mechanism” that when utilized with other components, operates the lift system 100 for lowering and lifting a person into or out of a body of water, swimming pool or spa.

The post 125 is sufficiently strong enough to carry a cantilevered load that will exceed the ADA load requirements without any undue bending or distortion. Although this lift system 100 works in conjunction with a hydraulic, air-activated cylinder, there are many other methods that can be utilized to achieve the same results. Some other options include a lead screw, rack-n-pinion, electric actuators, or a ratcheted device or pump.

Referring now to the drawing, part “A” is the post 125, which can be sized from 2″ to 12″, or any other suitable size. Approximately 4″ to 6″ is the size of the preferred embodiment. The shape of the post 125 can be square, round, hexagonal, or any other suitable shape. Having a shape other than round can be beneficial because it prevents rotation of the post 125 while in use. The post 125 can comprise any material that can be exposed to a wet environment without deteriorating, or materials coated with paints, epoxy, or any protective coating. The preferred embodiment comprises stainless steel or fiberglass. However, PVC with a reinforced metal core can also be used. Coated steel, aluminum, and reinforced plastic PVC are all other possible embodiments.

Part “B” is the sleeve. This is a bearing, bushing or slide that prevents side-to-side instability. It also acts as the bearing surface capable of carrying the load of the ADA weight limits. The sleeve can comprise bronze bushing, stainless steel, or abrasive resistant composites or plastics. Any other material that can withstand the load, abrasion, and wet conditions can also be utilized, but it must be of sufficient strength that when inserted into the receiving casing, it is strong enough to withstand the cantilevered load.

The cylinder plunger “C” is preferably constructed from stainless steel. Fiberglass, aluminum, PVC, reinforced plastics and any other suitable material can also be used for this part.

Part “D” is the O-ring seal on the lower part of the shaft.

The outer casing is “E” and is preferably constructed from stainless steel. Fiberglass, aluminum, PVC, reinforced plastics and any other suitable material can also be used for this part.

The relief hole is part “F”. This allows air to flow freely in and out of the cylinder above the plunger.

Part “G” is water. It can also be any other liquid, including antifreeze, oil, or any other suitable liquid.

Part “H” is the cylinder cap. This part is designed to stop component part “A” from rising beyond its required height. There is also a bottom cap that is sealed and creates the container that will be pressure-filled at location “G”, and this forces part “A” to raise and lower when liquid “Part I” is released and expels itself due to gravity.

Part “I” is the liquid in the cylinder.

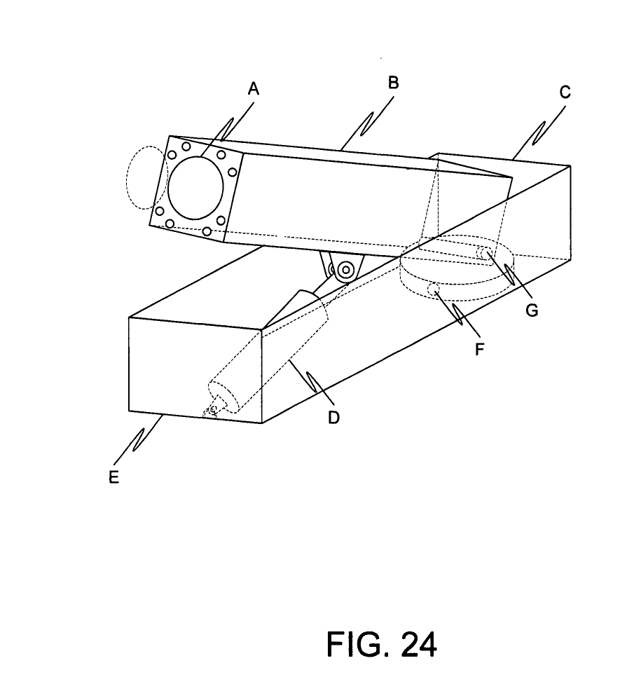

FIG. 24 is a perspective view of one embodiment of a hydraulic aquatic lift 100. This embodiment comprises a horizontal hoist, and can be installed underground and have a watertight seal.

Part “A” is a hydraulically-actuated post 125, which, when extended, connects to the beam 120 and chair 115.

Part “B” is a heavy-walled tube, which is an outer support casing for post “A”.

Part “C” shows that the edge of the bucket/container 105 can be level with the surrounding patio/ground.

Part “D” is a hydraulic lift.

Part “E” is the in-ground horizontal housing/container 105.

Part “F” is the back-end pivot point. It is an alternative embodiment which will allow the hydraulic lift “D” to rotate while lifting.

Part “G” is a pivot point for post “A”.

In some embodiments, post “A” may be connected directly to chair 115, in part because the pivot point “G” can act as the raising and lowering point.

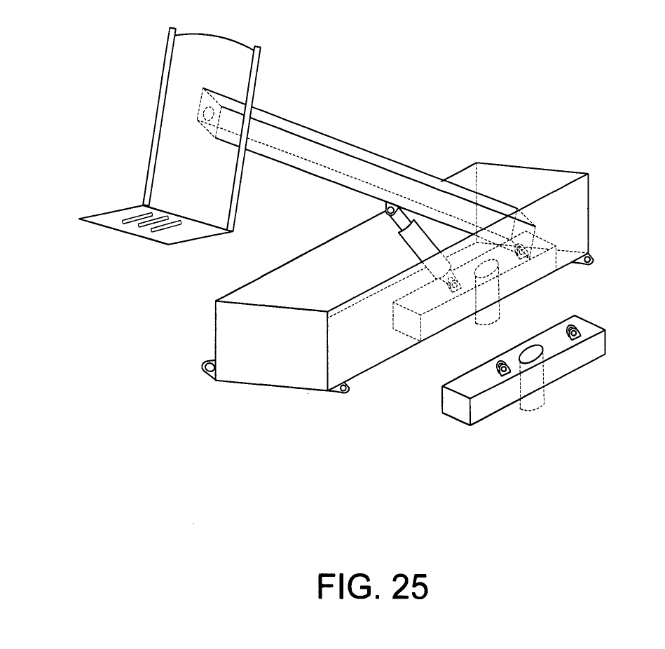

FIG. 25 is a perspective view of one embodiment of a hydraulic aquatic lift 100, showing an alternative embodiment of a swivel for the horizontal hoist of FIG. 24.

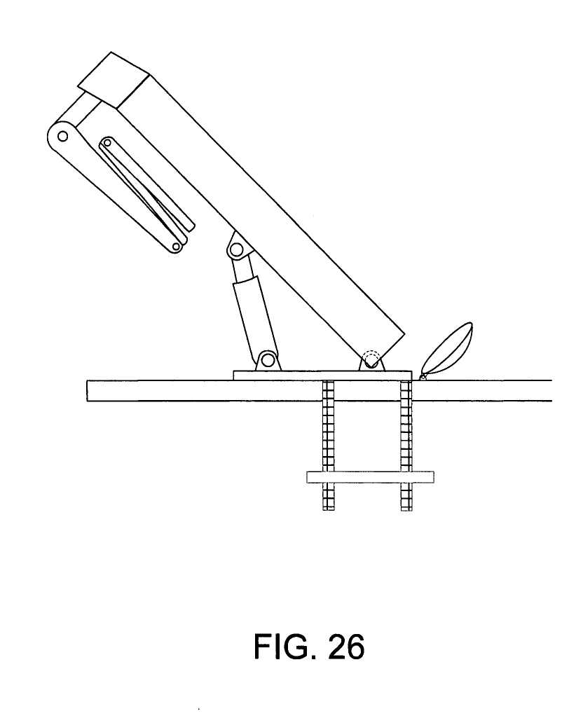

FIG. 26 is a side view of one embodiment of a hydraulic aquatic lift 100. Shown are further details of the horizontal hoist embodiment of FIGS. 24 and 25. The assembly can be mounted on a roller or bearing, similar to a lazy susan. It can be removable from the base, and the base may be provided with a lid for when the system 100 is not in use. The beam 120 and chair 115 can be attached or separate. The hydraulic cylinder in this embodiment, and in other embodiments, could be manually actuated.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged, or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without any other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A self-contained lift system comprising:
a lift post;
a swivel arm; and
a platform;
wherein the platform is connected to a first end of the swivel arm, the lift post is connected to a second end of the swivel arm, the lift post can be vertically displaced from a first vertical position to a second vertical position, and can be rotated from a first angular position to a second angular position.

2. The lift system of claim 1, wherein the lift post comprises a hydraulic cylinder.

3. The lift system of claim 1, wherein the lift post comprises a stationary outer tube, and a moveable inner tube which can be displaced from a first vertical position to a second vertical position.

4. The lift system of claim 1, wherein the swivel arm is attached to the lift post at a 90 degree angle.

5. The lift system of claim 1, wherein the swivel arm is attached to the lift post with a pivoting connector.

6. The lift system of claim 5, wherein the swivel arm can be folded until it is substantially parallel with the lift post.

7. The lift system of claim 1, wherein the platform comprises a bottom section and a back section.

8. The lift system of claim 7, wherein the platform comprises a seat.

9. The lift system of claim 8, wherein the seat is detachable from the swivel arm.

10. The lift system of claim 8, wherein the platform comprises a folding seat.

11. The lift system of claim 10, wherein the lift post, swivel arm, and platform fold together and fit into a container.

12. The lift system of claim 11, wherein the container is maintained below ground level.

13. The lift system of claim 11, wherein the container is maintained above ground level.

14. The lift system of claim 11, wherein the container is maintained partially below ground level.

15. The lift system of claim 11, wherein the container is water tight and air tight.

16. A method of using a lift system to move a person from a first position next to a swimming pool to a second position in the water of the swimming pool, the method comprising:
unstowing the lift system from the container;
securing the person to a platform;
moving the platform from a first vertical position to a second vertical position;
rotating the platform from a first angular position to a second angular position, wherein the first angular position is above the deck next of the swimming pool and the second angular position is over the water of the swimming pool;
moving the platform from a first vertical position to a second vertical position, wherein the first vertical position the platform is above the water of the swimming pool, and wherein the second vertical position the platform is submerged in the water of the swimming pool; and
unsecuring the person from the platform.

17. The method of claim 16, wherein the platform comprises a seat.

18. The method of claim 17, wherein the seat comprises arms.

19. The method of claim 17, wherein the seat comprises a seatbelt.

20. The method of claim 16, wherein the steps are performed in reverse, in order to move a person from a first position in the water of a swimming pool to a second position on the pool deck next to the swimming pool.
